(19) United States
(12) Patent Application Publication
(10) Pub. No.: US 2019/0290038 A1
(43) Pub. Date: Sep. 26, 2019

(54) WIRELESS HEATING CUP

(71) Applicant: ZeroLemon LLC, Cheyenne, WY (US)

(72) Inventors: Haosheng HUANG, Shenzhen (CN); Yongji HUANG, Shenzhen (CN)

(73) Assignee: ZeroLemon LLC, Cheyenne, WY (US)

(21) Appl. No.: 15/926,180

(22) Filed: Mar. 20, 2018

(51) Int. Cl. A47G 19/22; A47J 36/24; A47J 36/26; H02J 50/10

(52) U.S. Cl. CPC A47G 19/2288; A47J 36/2483; H02J 50/10; A47J 36/26; A47J 36/2472

(57) ABSTRACT

A wireless charging smart heating cup. The upper end of the cup body comes with a rotating cup mouth, which is provided with a floating cup stopper. The lower end of the cup body comes with a silicone cover. A battery and a heating piece are arranged between the cut body and the silicone cover. A rotating heating switch is arranged on the silicone cover, a chassis is arranged below the silicone cover, a wireless filling coil and a circuit board are arranged in the chassis, a display screen is arranged on the outer side of the chassis, the display screen is connecting with the chassis.

### BACKGROUND OF THE INVENTION

### 1. Field of the Invention

This invention is about a wireless charging smart heating cup, in the everyday life items technology field.

### 2. Background of the Invention

With the continuous improvement of science and technology and the continuous improvement of living standards, people's work pressure has also been constantly increasing. In the leisure time having a hot drink will to ease the pressure on work to some extent. At the same time, during normal daily activity like watching TV, chatting with friends, browsing internet, reading newspapers, people are used to have a cup of hot drink to relax. However, when the hot drink becomes cold, the taste is lacking because of the lower temperature. If we discard the drink and change to another hot drink will cause massive waste too. As there are limited heating cup option, people need to find another way to heat it up, which is very troublesome and time consuming. The Chinese patent announcement number CN201468835U made public a directly heating cup. Although this type of cup can heat the drink up directly, it need to be plugged in the power outlet in order to heat the drink. However, the power outlet is not always available and looks very messy in many business occasions and formal occasions like meetings. If people as the waiter to take away the drink to heat it up somewhere else, it will be time consuming and troublesome. This type of heating cup can only be used in limited places because of the power outlet.

### BRIEF SUMMARY OF THE INVENTION

To address the above issue, this invention shows a type of wireless charging smart heating cup.

The upper end of the cup body comes with a rotating cup mouthpiece, which is provided with a floating liquid stopper. The lower end of the cup body comes with a silicone cover. A battery and a heating piece are arranged between the cut body and the silicone cover. A rotating heating switch is arranged on the silicone cover, a chassis is arranged below the silicone cover, a wireless filling coil and a circuit board are arranged in the chassis, a display screen is arranged on the outer side of the chassis, the display screen is connecting with the chassis.

As a better option, the outer side of the cup body is provided with a non-slip grip position, which has good non-slip effect.

As a better option, The inside of the cup body is provided with a heat preservation liner, which has good heat insulation effect.

The benefit of this invention: The design of the structure is reasonable, with beautiful shape, and unique style, easy to use and convenient with multiple functions. When used in still, it can be used as wireless charger and wireless heating cup. When used in motion, the heating device inside can heat up the stuff inside, controlling the temperature and switch using mobile application. The outside of cup mouth utilizes up-down rotating floating cup stopper and anti-dirt design. The cup body uses mechanical rotation heating switch design, so people can heat and keep the temperature any time. The cup also heats up using conventional wireless phone charging apparatus such as Qi chargers.

### BRIEF DESCRIPTION OF THE SEVERAL VIEWS OF THE DRAWING

For easy explanation, the invention has the following figures attached for detailed description.

FIG. 1 is the structure explanation;

FIG. 2 is the rear view of FIG. 1;

FIG. 3 is three-dimensional structure diagram;

FIG. 4 is decomposition structure diagram.

### DETAILED DESCRIPTION OF THE INVENTION

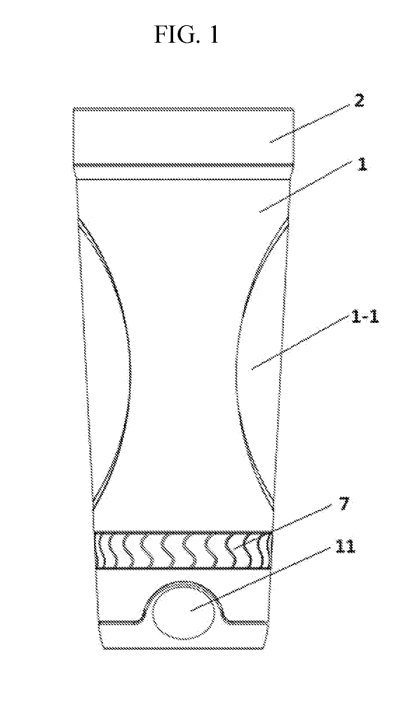

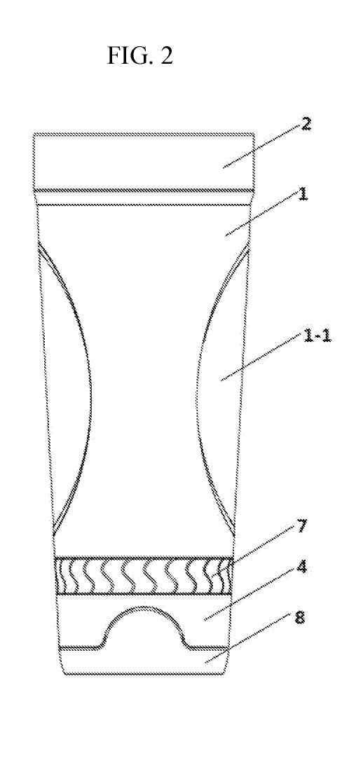

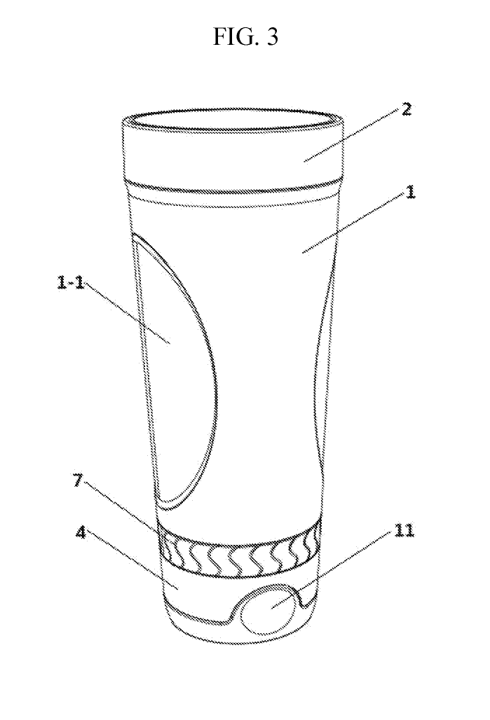

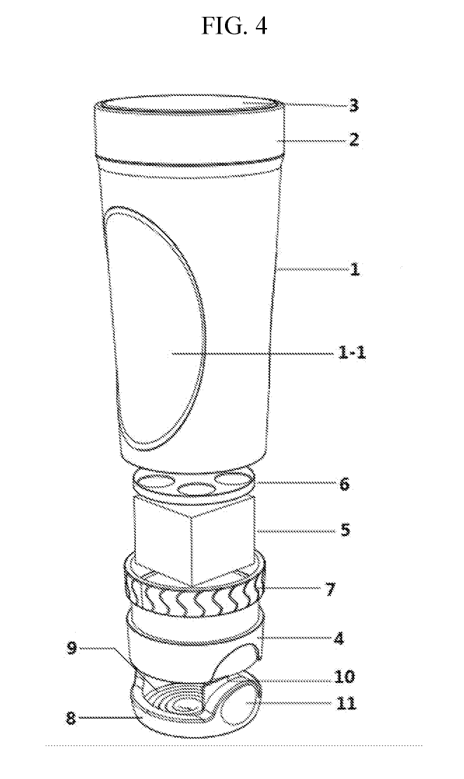

As shown in FIGS. 1-4, the detailed technical description is: it includes the cup body (1), rotating cup mouthpiece (2), floating liquid stopper (3), silicon cover (4), battery (5), heating piece (6), rotating heater switch (7), chassis (8), wireless filling coil (9), circuit board (10), display screen (11), on top of cup body (1) is rotating cup mouthpiece (2), on rotating cup mouth (2) is floating liquid stopper (3), bottom part of cup body (1) comes with silicon cover (4), between silicon cover (4) and cup body (1) are battery (5) and heating piece (6), on silicon cover (4) there is rotating heater switch (7), below the silicon cover (4) is the chassis (8), inside the chassis (8) there is wireless receiving coil (9) and circuit board (10), outside of wireless filling coil (8) there is display screen (11), display screen (11) is connected with circuit board (10).

The outer side of the cup body (l) is provided with a non-slip grip position (1-1), which has good non-slip effect. The inside of the cup body is provided with a heat preservation liner, which has good heat insulation effect.

The benefit of this invention: The design of the structure is reasonable, with beautiful shape, and unique style, easy to use and convenient with multiple functions. When used in still, it can use a wireless charger to heat the wireless heating cup while the mobile application is monitoring the temperature of the liquid. When used in motion, the heating device inside can heat up the liquid inside using mobile battery power source, controlling the temperature and switch using mobile application. The outside of cup mouthpiece utilizes up-down rotating floating liquid stopper and anti-dirt design. The cup body uses mechanical rotation heating switch design, so people can heat and keep the temperature constant at any time.

Above shows the basic fundamentals and main features and advantages of the invention. The technicians in this field should understand that the present invention is not limited to the above embodiments. The above description is only explaining the principle of the invention. Without departing from the spirit and scope of this invention, there are various changes and improvements. The scope of protection demanded by this invention is defined by the appended claims and their equivalents.

1. A wireless smart heating cup, comprising:
a cup body;
a rotating cup mouthpiece formed on top of the cup body,
a floating liquid stopper formed on an outside of the rotating cup mouthpiece, the floating liquid stopper being up-down rotatable;
a silicon cover formed below the cup body;
a battery and a heating piece formed between the silicon cover and the cup body;
a rotating heater switch formed on the silicon cover;
a chassis formed below the silicon cover;
a wireless filling coil and a circuit board formed inside the chassis; and
a display screen formed on an outer surface the chassis and being connected with the circuit board.

2. The wireless smart heating cup according to claim 1, further comprising an anti-slip grip bit formed on an outer surface of the cup body.

3. (canceled)
